(19) United States
(12) Patent Application Publication
(10) Pub. No.: US 2005/0261859 A1
(43) Pub. Date: Nov. 24, 2005

(54) Systems and methods for evaluating a test case

(76) Inventor: Jeremy Petsinger, Fort Collins, CO (US)

Correspondence Address: HEWLETT-PACKARD COMPANY;Intellectual Property Administration, P.O. BOX 272400, Fort Collins, CO, 80527-2400, US

(21) Appl. No.: 10/895,461

(22) Filed: May 24, 2004

(51) Int. Cl. G06F 19/00

(52) U.S. Cl. 702/120

(57) ABSTRACT

In one embodiment, a system and a method for evaluating a test case pertain to assigning weights to at least one of system components and system events, processing the test case to determine the number of event occurrences observed when the test case was run, and computing an overall score for the test case relative to the number of occurrences and the assigned weights.

### BACKGROUND

Integrated circuit design, such as processor design, is an extremely complex and lengthy process. The design process includes a range of tasks from high-level tasks, such as specifying the architecture, down to low-level tasks, such as determining the physical placement of transistors on a silicon substrate. Each stage of the design process also involves extensive testing and verification of the design through that stage. One typical stage of processor design is to program the desired processor architecture using a register transfer language (RTL). The desired architecture is represented by an RTL specification that describes the behavior of the processor in terms of step-wise register contents. The RTL specification models the function of the processor without describing the physical details. Thus, the processor architecture can be verified at a high level with reference to the RTL specification, independent of implementation details such as circuit design and transistor layout. The RTL specification also facilitates later hardware design of the processor.

The RTL specification is tested using test cases. The test cases comprise programs that define an initial state for the processor that is being simulated and the environment in which it operates. Such test cases are generated, by way of example, by a pseudo-random generator. During verification testing of a processor, literally millions of these test cases are run on the RTL specification. Execution of so many test cases enables verification of every component of the processor design in a variety of situations that may be encountered during processor operation.

Certain test cases are better than others at testing particular components or conditions. For example, when multiple test cases are run, there will be a subset of test cases that are best at testing a memory subsystem of the processor design. Given the sheer number of test cases that are typically run, however, it can be difficult to determine which test cases are best for testing which components or conditions. This is disadvantageous given that the design tester may wish to identify and apply only certain test cases in a given situation. For instance, in keeping with the previous example, if the memory subsystem has been modified during the design process, it may be desirable to identify and apply those test cases that are best suited to test the memory subsystem.

Due to the desirability of identifying test cases, mechanisms have been employed to identify the occurrence of given events in relation to particular test cases. Although such mechanisms can help quantify the number of events that are observed for any given test case, those mechanisms do not provide the design tester with an evaluation or measure of the test case's ability to test particular components or conditions.

### SUMMARY

In one embodiment, a system and a method for evaluating a test case pertain to assigning weights to at least one of system components and system events, processing the test case to determine the number of event occurrences observed when the test case was run, and computing an overall score for the test case relative to the number of occurrences and the assigned weights.

### BRIEF DESCRIPTION OF THE DRAWINGS

The disclosed systems and methods can be better understood with reference to the following drawings. The components in the drawings are not necessarily to scale.

FIG. 1 is a block diagram of a first exemplary system for verifying a processor architecture.

FIG. 2 is a block diagram of a second exemplary system for verifying a processor architecture.

FIG. 3 is a block diagram of a first exemplary interface for an RTL specification shown in FIGS. 1 and 2.

FIG. 4 is a block diagram of a second exemplary interface for an RTL specification shown in FIGS. 1 and 2.

FIG. 5 is a first schematic representation of components and associated events of a system design that is to be tested.

FIG. 6 is a flow diagram of an embodiment of method for evaluating the functional coverage of a test case.

FIG. 7 is a second schematic representation of components and associated events of a system design that is to be tested.

FIG. 8 is a flow diagram of an example method for evaluating a test case.

FIG. 9 is a block diagram of an example computer system on which test cases can be evaluated for functional coverage.

### DETAILED DESCRIPTION

Disclosed are systems and methods for evaluating the functional coverage of test cases. More particularly, disclosed are systems and methods for evaluating the functional coverage of test cases applied to an integrated circuit design for the purpose of identifying the test cases that are best suited to test particular circuit components or conditions that may arise in operation of the circuit. In the following, the underlying integrated circuit is described as being a computer processor. It is to be understood, however, that the systems and methods described herein apply equally to other types of integrated circuits, including application-specific integrated circuits (ASICs).

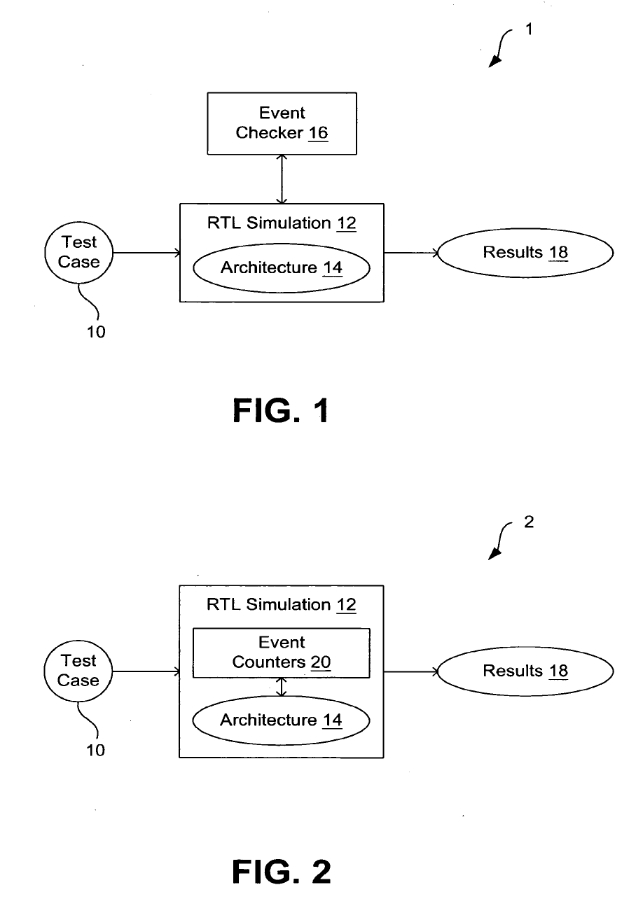

Referring to FIG. 1, an example processor architecture verification system 1 is illustrated that verifies processor architecture by executing at least one test case 10 on a compiled register transfer language (RTL) specification 12. As is described below, the RTL specification 12, for example, comprises a front side bus (FSB) output interface or a point-to-point (P2P) link network output interface.

The RTL specification 12 is operated relative to information specified by the test case 10. The test case 10 comprises a program to be executed on the processor architecture 14 in the RTL specification 12. The test case 10 is a memory image of one or more computer-executable instructions, along with an indication of the starting point, and may comprise other state specifiers such as initial register contents, external interrupt state, etc. Accordingly, the test case 10 defines an initial state for the processor that is being simulated and the environment in which it operates. The test case 10 may be provided for execution on the RTL specification 12 in any suitable manner, such as an input stream or an input file specified on a command line.

The RTL specification 12 may be implemented using any suitable tool for modeling the processor architecture 14, such as any register transfer language description of the architecture that may be interpreted or compiled to act as a simulation of the processor. The RTL specification 12 of an exemplary embodiment contains an application program interface (API) that enables external programs to access the state of various signals in the simulated processor, such as register contents, input/outputs (I/Os), etc. Thus, the output of the RTL specification 12 may be produced in any of a number of ways, such as an output stream, an output file, or as states that are probed by an external program through the API. The RTL specification 12 may simulate any desired level of architectural detail, such as a processor core, or a processor core and one or more output interfaces.

In the embodiment of FIG. 1, the system 1 includes an event checker 16 that accesses the RTL specification 12 to detect various events that occur during execution of the test case 10. As is described in greater detail below, the detected occurrences of such events are used to evaluate the test case 10. As shown in FIG. 1, the event checker 16 is external to the RTL specification 12. Accordingly, the event checker 16 observes the behavior of the RTL specification 12 during execution of a test case 10 from a relatively high level. As is further illustrated in FIG. 1, the results 18 of the test case 10 are output from the RTL simulation.

FIG. 2 illustrates an alternative configuration for the system shown in FIG. 1. Specifically, FIG. 2 illustrates a processor architecture verification system 2 that is similar to the system 1, except that the RTL specification 12 is instrumented with event counters 20 that monitor for particular events that occur within the RTL specification during execution of the test case 10. In contrast to the event checker 16 of FIG. 1, the event counters 20 observe all low-level transactions that occur within the simulated processor and, therefore, observes RTL specification operation at a relatively low level.

Notably, other embodiments of a processor architecture verification system may comprise a hybrid of the embodiments shown in FIGS. 1 and 2. For instance, such a system may comprise both an external event checker and internal event counters. In such a case, the RTL specification 12 can be monitored for events on both a low-level and a high-level scale.

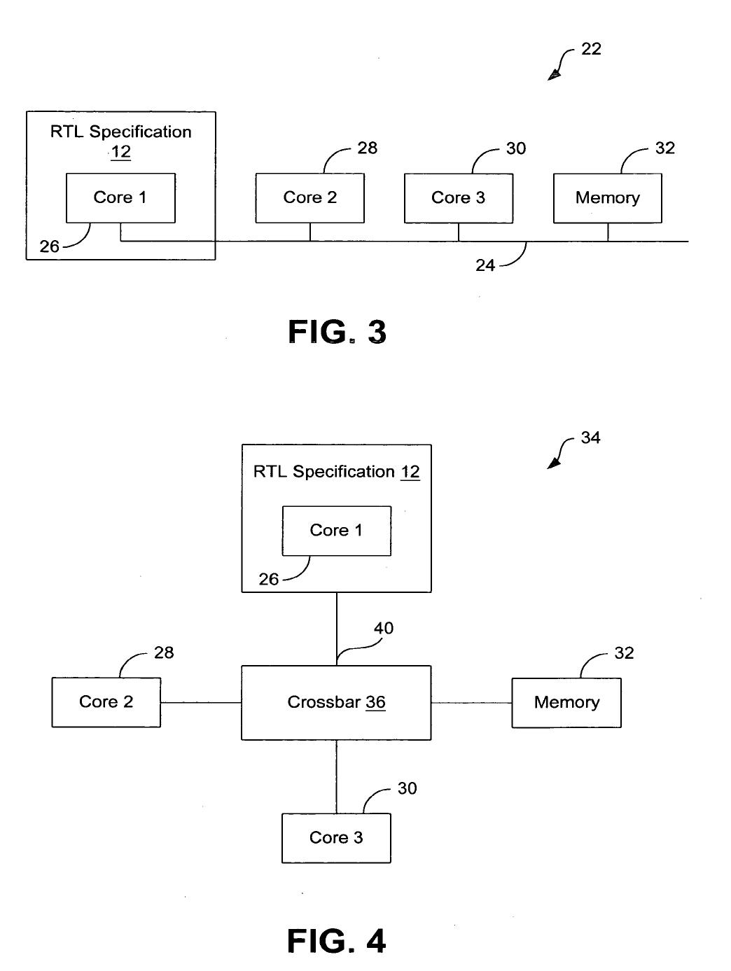

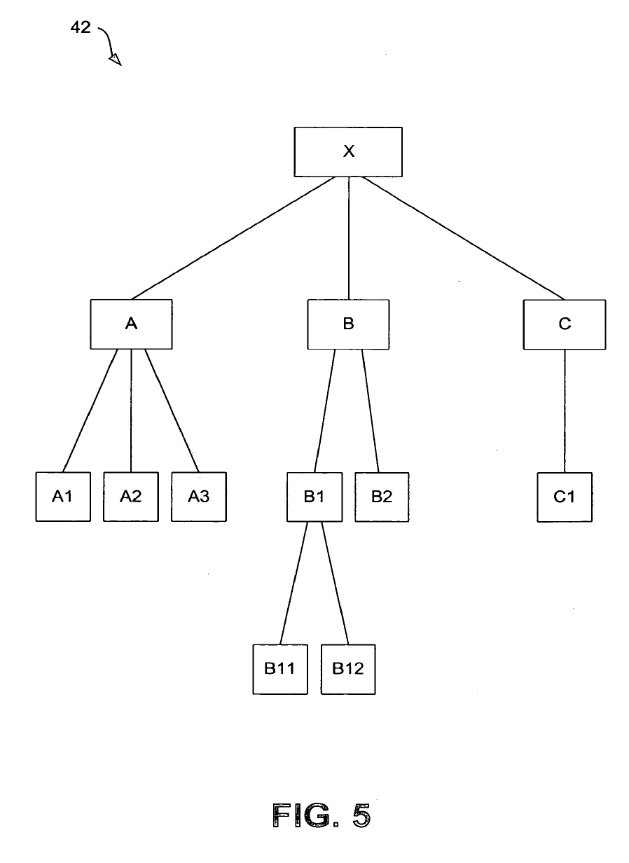

FIGS. 3 and 4 illustrate exemplary output interfaces of the RTL specification 12. Beginning with FIG. 3, illustrated is an interface 22 that includes a front side bus (FSB) 24. In the embodiment of FIG. 3, a simulated processor core 26, Core 1, based on the desired architecture 14, is connected to the FSB 24 and therefore to external components such as other simulated processor Cores 2 and 3 (28 and 30), a memory 32, etc. The external components may, in some cases, comprise actual, physical devices. For example, the memory 32 may be a portion of the memory of the computer executing the RTL specification 12. Alternatively, one or more of the external components may be simulated components that are either simulated by the RTL specification 12, or by an external simulator. In a further alternative, one or more of the external components may be virtual components represented by pre-programmed responses in the test case 10 that are issued in response to transactions from the simulated Core 1 (26).

The FSB 24 is a broadcast bus in which bus traffic is visible to each agent connected to the FSB. Each component on the bus 24 monitors the traffic to determine whether the traffic is addressed to them. A given operation or “transaction” performed by Core 1 (26), such as a memory read operation, may comprise multiple phases. For example, consider an exemplary read operation performed by the Core 1 (26) using the FSB 24 to read data from the memory 32. Such a transaction may comprise an arbitration phase, a request A, a request B, a snoop phase, and a data phase. Each of these five phases is performed by transmitting or receiving a block of information over the FSB 24. The different phases are defined in the FSB output format and place the system into various states. For example, during the snoop phase, the transaction becomes globally visible so that the transaction is visible to each core 26, 28, and 30, thereby facilitating a shared memory architecture.

FIG. 4 illustrates an interface 34 that comprises a point-to-point (P2P) link network. The P2P link network is a switch-based network with one or more crossbars 36 that act as switches between system components such as processor cores 26, 28, and 30, and memory 32. Transactions are directed to specific components and are appropriately routed in the P2P link network by the crossbar 36. Operation of the crossbar 36 reduces the load on the system components because they do not need to examine each broadcast block of information as with the FSB 24. Instead, each component ideally receives only data meant for that component. Use of the crossbar 36 also avoids bus loading issues that can plague FSB systems. Therefore, the P2P link network facilitates better scalability. Transactions on the P2P link network are packet-based, with each packet containing a header with routing and other information. Packets containing requests, responses, and data are multiplexed so that portions of various transactions may be executed with many others at the same time. Transmissions are length-limited, with each length-limited block of data called a “flit.” Thus, a long packet will be broken into several flits, and transactions will typically require multiple packets. Such activity, or events, on the network are observed by the event checker (e.g., checker 16, FIG. 1) and/or by the event counters (e.g., counters 20, FIG. 2), depending upon the system configuration.

As noted above, certain test cases are better than others at testing particular processor components or conditions (i.e., events). FIG. 5 is a schematic representation of various components of a given system design (e.g., a processor design), and various events that pertain to each of those components, shown within a tree structure 42. In the illustrated tree structure 42, block X is the top node and represents the system as a whole, or a portion of the system that includes all components below that level. Below the top node are component nodes A, B, and C, which represent various components of the system. For example, node A may pertain to a floating point unit, node B may pertain to a memory subsystem, and node C may pertain to a memory cache.

Below the components nodes A, B, and C are further nodes A1, A2, A3, B1, B2, and C1. Each of these nodes pertains to either an event or a sub-component that is associated with one of the components A, B, and C. For instance, node A1 may pertain to a first arithmetic action (e.g., multiplication of first and second operands), node A2 may pertain to a second arithmetic action (e.g., addition of first and second operands), node A3 may pertain to a third arithmetic action (e.g., subtraction of a second operand from a first operand), node B1 may pertain to a first queue in the memory subsystem B, node B2 may pertain to a second queue in the memory subsystem B, and node C1 may pertain to a full condition of the cache C. As is further illustrated in FIG. 5, the tree structure 42 includes a further level of nodes that includes nodes B11 and B12, each of which are associated with node B1. By way of example, node B11 may pertain to filling of queue B1 and node B12 may pertain to an attempt to add a transaction to queue B1.

In view of the above example, each leaf node, i.e., each end node from which no other nodes depend, pertains to a given event for which the design tester (i.e., user) may wish to collect information, whether that event is associated with a main component (e.g., A, B, or C) or a sub-component (e.g., B1 or B2). The event checker 16 and/or the event counters 20 (depending upon the particular system implementation) is/are configured to detect the occurrence of the various events for the purpose of enabling analysis of those events to provide the design tester with an idea of how well a given test case tests those particular events. Specifically, the event checker 16 and/or event counters 20 identify the number of occurrences of each tracked event and weight is applied to each according to the each event's importance relative to a particular system component or condition about which the design tester is interested. Accordingly, through such weighting, each test case can be evaluated to generate relative scores that measures the ability of the test case to test the given system component or condition. When such analysis is performed upon each test case of a group of test cases (e.g., each test case that has been run to date), an ordered list of best to worst for testing the given component or condition can be provided to the design tester.

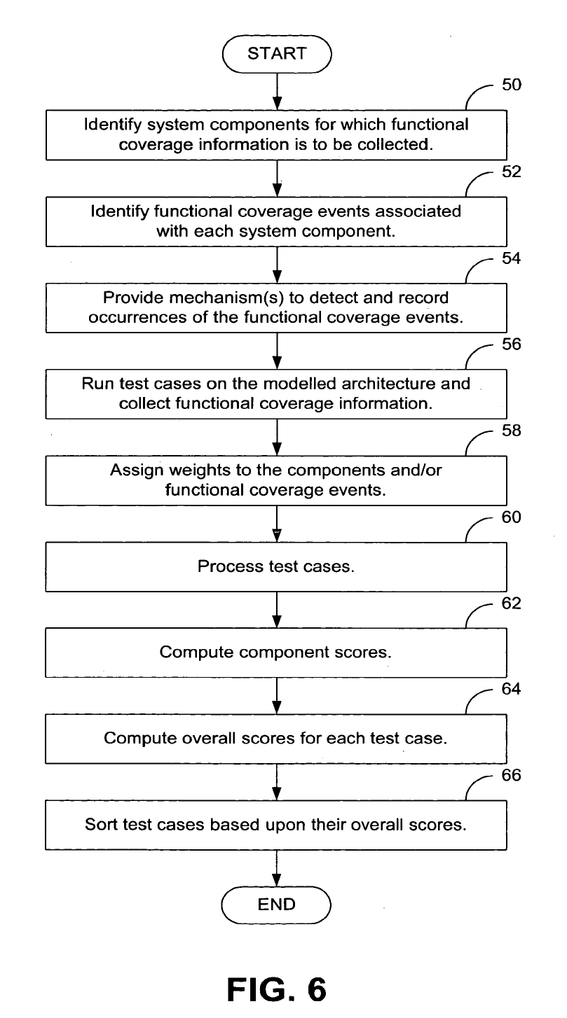

FIG. 6 is a flow diagram that describes an example method for evaluating test cases to measure their suitability for testing given components or conditions. Beginning with block 50, the system components for which functional coverage information is to be collected are identified. Assuming the system configuration of FIG. 5, these components would include the floating point unit (node A), the memory subsystem (node B), and the memory cache (node C). Next, with reference to block 52, the functional coverage events associated with each system component are identified. In the example of FIG. 5, these events include various arithmetic actions (leaf nodes A1, A2, and A3), filling of a queue (leaf node B11), an attempt to add a transaction to the queue (leaf node B12), and a full cache condition (leaf node C1).

Once each system component and functional coverage event of interest is identified, the mechanisms to detect and record occurrences of the various functional coverage events are provided within the verification system, as indicated in block 54. As mentioned in the foregoing, these mechanisms can include one or more of an event checker (e.g., checker 16, FIG. 1) and event counters (e.g., counters 20, FIG. 2). In the latter case, the RTL specification is instrumented with counters that monitor the RTL specification interface (FSB or P2P, FIGS. 3 and 4) for transactions that correspond to the identified functional coverage events. Irrespective of which mechanisms are employed, they are provided within the verification system prior to running of the test cases that are to be evaluated to measure their effectiveness in testing certain system components or conditions.

Referring next to block 56, various test cases are run on the modeled architecture (e.g., processor design), and the functional coverage information for which the verification system was configured to obtain is collected. By way of example, the functional coverage information can be stored in association with the various test cases in a test case database in which other test case results are stored.

At this point, some or all of the test cases that have been run can be evaluated by a test case evaluator program to determine which test case or cases is/are best for testing certain aspects of the system design, such as particular system components or conditions. To conduct this evaluation, the various test cases are analyzed and scored relative to their ability to test the component(s) or condition(s) of interest. This is accomplished by providing greater weight to collected information that pertains to the specific components and/or events about which the design tester is interested. Accordingly, with reference to block 58, the test case evaluator (e.g., in response to a selection made by the design tester) assigns weights to the components and/or functional coverage events so that the information associated with those components and/or events is allotted greater importance and, therefore, the test cases that have higher occurrences of the events associated with the components will receive higher scores.

Such weight can be assigned, for example, prior to conducting the test case evaluation. For instance, the design tester can be prompted to set those weights to suit his or her search for suitable test cases. Notably, weight can be individually assigned to the components as well as the events associated with those components. Therefore, in terms of the tree structure 42 of FIG. 5, weights can be assigned to nodes as well as leaf nodes. If the design tester is interested in identifying the test cases that, for example, best test a floating point unit of the modeled architecture, the design tester can assign greater weight to the floating point unit than the memory subsystem and the memory cache. In addition or in exception, the design tester can assign greater weights to the events associated with the floating point unit (events A1, A2, and A3 in FIG. 5) than the events associated with the other components (events B11 , B12, and C1 in FIG. 5).

With reference next to block 60, the test case evaluator processes the test cases. For instance, the evaluator processes all of the test cases contained in a test case database, or a subset of those test cases if the design tester has so chosen. In processing the test cases, the test case evaluator determines the number of occurrences for each event for which information was collected. Optionally, the test case evaluator limits the number of event counts for certain events. In such a situation, cases in which occurrences of a given event beyond a given number of times (e.g., once) are not considered probative of the test case's value for testing a particular system component or condition, all occurrences beyond the given number of times can be ignored. For instance, if the design tester is only interested in the first 10 occurrences of a given event, and 15 occurrences were observed for that event in a given test case, the number of occurrences counted for purposes of the evaluation is limited to 10. Such event count limits can, for example, be established by the design tester prior to running the test case evaluation.

In addition to limiting the event counts, the test case evaluator can further separately normalize the weights assigned to the components and events so as to render the results of the evaluation more suitable for comparison with each other. Such normalization comprises dividing each event's weight by the sum of all the applicable event weights. For example, in FIG. 5, if the weights for A1, A2, and A3 were 5, 15, and 30, respectively, normalizing unit A for a maximum value of 1 (so that the possible score for unit A would range from 0 to 1) would result in normalized weights of A1=0.1 or 5/(5+15+30), A2=0.3 or 15/(5+15+30), and A3=0.6 or 30/(5+15+30). At this point, the test case evaluator computes the component scores for each test case, as indicated in block 62. In this process, the number of occurrences for each event (optionally limited to a maximum number) are multiplied by the applicable assigned weights (optionally normalized as described above). When the scores for each type of event associated with a given component are added together, a component score results. Once all such component scores have been calculated, the overall scores are computed for each test case, as indicated in block 64. Those scores are obtained by multiplying the component scores by the applicable component weights (optionally normalized as described above), and then adding the weighted scores together. When this process is conducted for each test case under evaluation, scores are generated for each of the test cases that indicate the suitability of the test cases for the particular component or condition in which the design tester is interested. Accordingly, the test cases can be ranked based upon their overall scores, as indicated in block 66. When a ranking (i.e., list) of the test cases and their scores is presented to the design tester, those at the top of the test case list (i.e., those having the highest scores) will be those that are best suited to test the component or condition of interest.

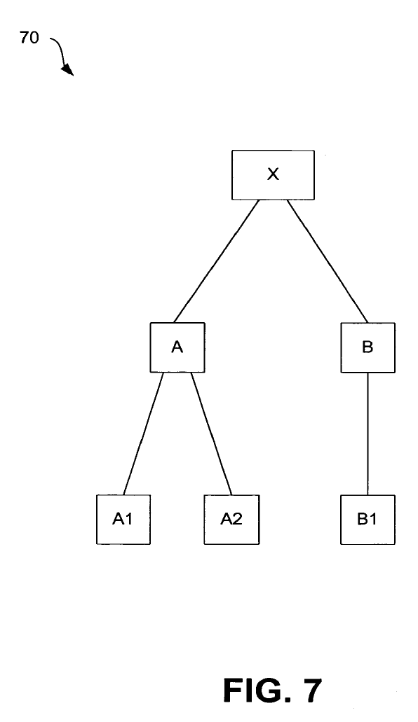

An example of the above-described process will now be described in view of the example tree structure 70 of FIG. 7. By way of example, this tree structure 70 comprises a portion of a larger tree structure (not shown) that represents a modeled architecture that is being verified (e.g., a processor architecture). It is assumed for this example that the tree structure 70 represents an arithmetic logic unit (ALU), designated by node X. The ALU (node X) includes various sub-components including an adder (node A) and a multiplier (node B). Both of those sub-components include at least one functional coverage event for which information will be collected. In this example, the events associated with the adder include an overflow event (leaf node A1) and an unsigned addition (leaf node A2), and the event associated with the multiplier includes an overflow event (leaf node B1).

Assume that the design tester (i.e., user) considers overflow events to be more important than unsigned additions. In such a case, the design tester may assign a weight of 10 to leaf nodes A1 and B1, and a weight of 5 to leaf node A2. Assume further that the design tester considers the multiplier to be more complex (and therefore more important to test) than the adder. In such a case, the design tester may assign a weight of 10 to node B and a weight of 5 to node A. Therefore, the assigned weights are as follows:
A=5
A1=10
A2=5
B=10
B1=10

Next, it is assumed that the design tester wishes to normalize those weights. Such normalization results in the following normalized weights:
A=0.33
A1=0.67
A2=0.33
B=0.67
B1=1.0

In addition to normalizing the weights, assume that the design tester wishes to place limits on the number of event occurrences that will count in the test case evaluation. For example, assume that a limit of 1 is assigned to leaf node A1, a limit of 3 is assigned to leaf node B1, and a limit of 100 is assigned to A2.

If a given test case is observed to cause 2 overflow events on additions, 6 overflow events on multiplies, and 50 unsigned additions, the scores for each event are as follows:
A1: (1/1)(0.67)=0.67
A2: (50/100)(0.33)=0.165
B1: (2/3)(1.0)=0.67

With those event scores, the component scores are calculated as follows:
A: (0.67+0.165)(0.33)=0.28
B: (1.0)(0.67)=0.67

Next, the overall score for the test case can be calculated as the sum of the two components scores, or 0.95.

In view of the above, the disclosed evaluation systems and methods provide an effective tool to aid design testers in selecting test cases to evaluate specific components of a design, or conditions that may arise during operation of the underlying architecture. In addition to identifying test cases that are effective in testing individual components, the evaluation systems and methods can be used to identify test cases that are best suited for testing multiple components. Such flexibility is possible through the weight assignment process. Furthermore, the evaluation systems and methods are easy to use, even for design testers that are not highly familiar with the underlying design, because relative scores are provided that enable simple identification of the most suitable test cases.

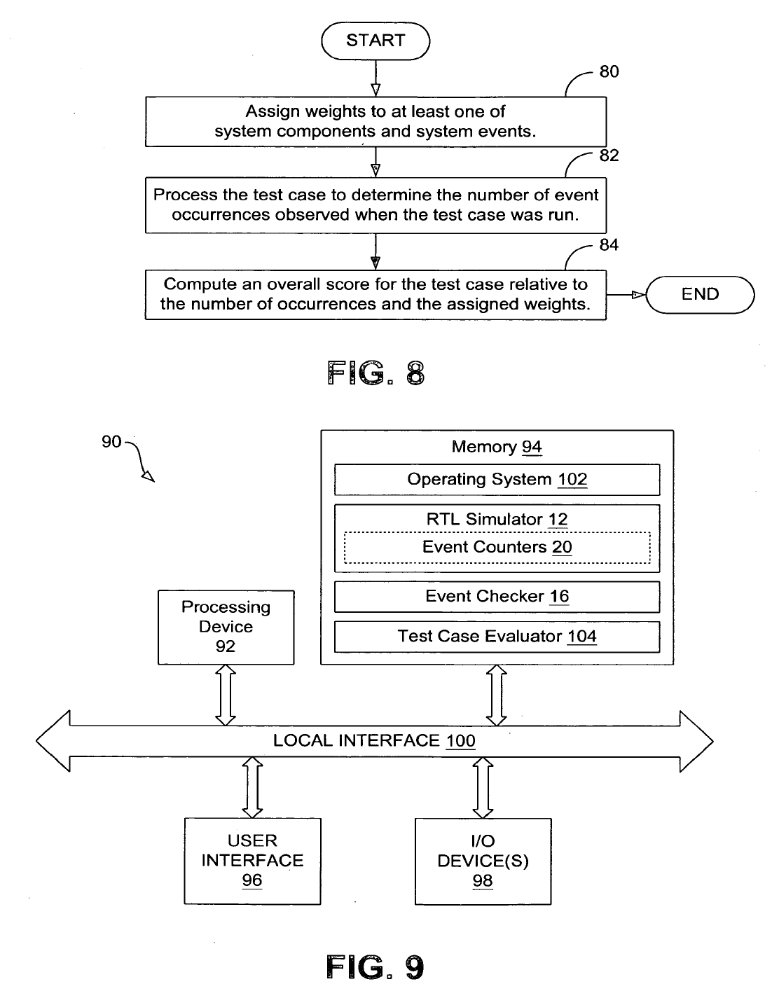

FIG. 8 is a flow diagram of an example method for evaluating a test case. As is indicated in that figure, the method comprises assigning weights to at least one of system components and system events (block 80), processing the test case to determine the number of event occurrences observed when the test case was run (block 82), and computing an overall score for the test case relative to the number of occurrences and the assigned weights (block 84).

FIG. 9 is a block diagram of a computer system 90 in which the foregoing systems can execute and, therefore, a method for evaluating test cases for functional coverage can be practiced. As indicated in FIG. 9, the computer system 90 includes a processing device 92, memory 94, at least one user interface device 96, and at least one input/output (I/O) device 98, each of which is connected to a local interface 100.

The processing device 92 can include a central processing unit (CPU) or an auxiliary processor among several processors associated with the computer system 90, or a semiconductor-based microprocessor (in the form of a microchip). The memory 94 includes any one or a combination of volatile memory elements (e.g., RAM) and nonvolatile memory elements (e.g., read only memory (ROM), hard disk, etc.).

The user interface device(s) 96 comprise the physical components with which a user interacts with the computer system 90, such as a keyboard and mouse. The one or more I/O devices 98 are adapted to facilitate communication with other devices. By way of example, the I/O devices 98 include one or more of a universal serial bus (USB), an IEEE 1394 (i.e., Firewire), or a small computer system interface (SCSI) connection component and/or network communication components such as a modem or a network card.

The memory 94 comprises various programs including an operating system 102 that controls the execution of other programs and provides scheduling, input-output control, file and data management, memory management, and communication control and related services. In addition to the operating system 102, the memory 94 comprises the RTL specification 12 identified in FIGS. 1 and 2. As is shown in FIG. 9, the RTL specification 12 optionally includes the event counters 20. In addition, the RTL specification 12 optionally includes an event checker 16. Finally, the memory includes the test case evaluator 104, which has been described above.

Various programs (i.e., logic) have been described herein. Those programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

1. A method for evaluating a test case used to test a system design, the method comprising:
assigning weights to at least one of system components and system events;
processing the test case to determine the number of event occurrences observed when the test case was run; and
computing an overall score for the test case relative to the number of occurrences and the assigned weights.

2. The method of claim 1, wherein assigning weights comprises assigning weights to each of system components and system events associated with the system components.

3. The method of claim 1, wherein assigning weights comprises assigning greater weights to system components and system events that are most relevant to a component or condition of interest.

4. The method of claim 1, wherein processing the test case comprises identifying the number of event occurrences observed by at least one of an external event checker and internal event counters.

5. The method of claim 1, wherein processing the test case further comprises limiting the number of particular event occurrences that will count in computing the overall score.

6. The method of claim 1, wherein processing the test case further comprises normalizing the assigned weights prior to computing an overall score.

7. The method of claim 6, wherein normalizing the assigned weights comprises separately normalizing weights assigned to system components and system events.

8. The method of claim 1, wherein computing an overall score comprises computing scores for each system event by multiplying the number of occurrences for each event by a weight assigned to that event.

9. The method of claim 8, wherein computing an overall score further comprises computing scores for each system component by adding the scores of the system events associated with each component and multiplying by a weight assigned to that component.

10. The method of claim 9, wherein computing an overall score further comprises adding each component score to obtain the overall score.

11. The method of claim 1, further comprising ranking the test case with other test cases by overall score to provide an indication of the suitability of each of the test cases.

12. A system for evaluating test cases, the system comprising:
means for detecting occurrences of system events;
means for assigning weights to system components and system events;
means for processing test cases to determine the number of times system events occur during running of test cases; and
means for computing overall scores for test cases relative to the number of occurrences and the assigned weights.

13. The system of claim 12, wherein the means for detecting occurrences comprise at least one of an external event checker and internal event counters.

14. The system of claim 12, further comprising means for limiting the number of event occurrences that will count in computing an overall score.

15. The system of claim 12, further comprising means for normalizing assigned weights.

16. The system of claim 12, wherein the means for computing an overall score comprise means for computing scores for each system event by multiplying the number of occurrences by a weight assigned to that event, means for computing scores for each system component by adding the scores of the system events associated with each component and multiplying by a weight assigned to that component, and means for adding each component score to obtain the overall score.

17. The system of claim 12, further comprising means for ranking test cases by overall score.

18. A test case evaluation system stored on a computer-readable medium, the system comprising:
logic configured to assign normalized weights to at least one of system components and system events;
logic configured to determine the number of event occurrences observed during running of a test case;
logic configured to compute overall scores for test cases relative to the number of event occurrences and the normalized weights; and
logic configured to rank test cases by overall scores.

19. The system of claim 18, wherein the logic configured to assign normalized weights comprises logic configured to assign separately normalized weights to each of system components and system events.

20. The system of claim 18, wherein the logic configured to determine the number of event occurrences comprise at least one of an external event checker and internal event counters.

21. The system of claim 18, further comprising logic configured to limit the number of event occurrences that count in computing an overall score.

22. The system of claim 18, wherein the logic configured to compute overall scores comprises logic configured to multiply numbers of occurrences by event weights.

23. The system of claim 22, wherein the logic configured to compute overall scores further comprises logic configured to add event scores and multiply by component weights.

24. The system of claim 23, wherein the logic configured to compute overall scores further comprises logic configured to add component scores.

25. A computing system, comprising:
a processing device; and
memory including a test case evaluator that is configured to assign weights to system components and system events, to determine the number of event occurrences observed relative to each of several test cases, to compute overall scores for the test cases relative to the number of event occurrences and the normalized weights, and to rank the test cases by overall scores.

26. The system of claim 25, wherein the test case evaluator is configured to assign separately normalized weights to each the system components and system events.

27. The system of claim 25, wherein the test evaluator is further configured to limit the number of event occurrences that count in computing overall scores.

28. The system of claim 25, wherein the test evaluator is further configured to multiply occurrences by event weights, add event scores and multiply by component weights, and add component scores.
